(19) United States
(12) Patent Application Publication
(10) Pub. No.: US 2005/0014544 A1
(43) Pub. Date: Jan. 20, 2005

(54) Mahjong game machine and program product therefor

(75) Inventor: Toshiomi Nara, Tokyo (JP)

Correspondence Address: MCGINN & GIBB, PLLC, 8321 OLD COURTHOUSE ROAD, SUITE 200, VIENNA, VA, 22182-3817, US

(73) Assignee: Aruze Corp., Tokyo (JP)

(21) Appl. No.: 10/882,284

(22) Filed: Jul. 2, 2004

(30) Foreign Application Priority Data
Jul. 4, 2003 (JP) P2003-192406

(51) Int. Cl. A63F 13/00

(52) U.S. Cl. 463/13

(57) ABSTRACT

A mahjong game machine has display device for displaying images showing at least holding tiles and discarded tiles of a player and images showing discarded tiles of a opponent character which is a competitor of a game, the game machine provides two-player-mahjong game in which the player plays against one from of a plurality of opponent characters. The game machine further includes prize awarding device for receiving a completion of a game by the player with a specific combination of tiles and awarding a predetermined prize to the player.

### CROSS-REFERENCE TO THE RELATED APPLICATION(S)

This application is based upon and claims a priority from prior Japanese Patent Application No. 2003-192406 filed on Jul. 4, 2003, the entire contents of which are incorporated herein by reference. This application is related to co-pending U.S. patent applications claiming priorities on JP-2003-192398, JP-2003-192399, JP-2003-271136, JP-2003-271138, JP-2003-192404, JP-2003-271140 and JP-2003-271141, and filed on even date herewith. The co-pending U.S. patent applications are expressly incorporated herein by reference.

### BACKGROUND OF THE INVENTION

1. Field of the Invention

The present invention relates a mahjong game machine providing a mahjong game, and a program product for the mahjong game machine applicable for a personal computer or a device including a computer such as a cellular phone and the like, other than the mahjong game machine.

2. Description of the Related Art

Conventionally, there is known a mahjong game machine providing a two-player-mahjong game in which a player plays against an opponent character (see JP-UM-A-4-070089). In such a mahjong game machine, images showing holding tiles and discarded tiles of the player or images showing discarded tiles of the opponent character as well as an image showing a mahjong table, are displayed on a display device. In accordance with operation of the player, the mahjong game is continued in such a manner to repeat actions that the player and the opponent character pick up and discard tiles. If the player makes his holding tiles close to completion and then completes in advance of the opponent character, the player acquires from the opponent character scores corresponding to an established combination according to a combination of his tiles. Further, if the player wins over the opponent character by making scores of the opponent character zero, etc., a state in which the opponent character applauds the superior game ability of the player is displayed on the display device.

### SUMMARY OF THE INVENTION

However, in the above-described mahjong game machine, players are repeatedly engaged in playing against the same opponent character many times. Consequently, there is a problem in that players can become easily bored with the game after playing it for many times.

Further, even when players win with a specific combination of tiles which could be rarely accomplished, the players acquires no prize other than scores. As a result, problems rise in that the players become uninterested in the mahjong game and in a difficult condition there is not much incentive to continue the mahjong game.

Moreover, even when the players win with a specific combination of tiles, there is no method for verification which leads to a further problem in that the player could not boast their scores to other player.

The present invention is made in consideration with the above-described problems, and one of objects of the invention is to provide a mahjong game machine that is capable of, if the player win with a specific combination of tiles which is rarely accomplished, enhancing the player's entertainment and allowing the players to enjoy the mahjong game without becoming bored, and a program product for a game device to be used in the mahjong game machine.

According to a first aspect of the invention, there is provided a mahjong game machine for providing a two-player-mahjong game in which a player plays the mahjong game against one from a plurality of opponent characters, the mahjong game machine including: a display device that displays an image of holding tiles and discarded tiles of the player and of the opponent character; and a prize awarding device that awards a prize to the player when the player completes the mahjong game with a specific combination of tiles.

According to a second aspect of the invention, there is provided a computer-readable program product for providing a two-player-mahjong game in which a player plays the mahjong game against one from a plurality of opponent characters, the program product for causing a computer to execute the steps of: displaying an image of holding tiles and discarded tiles of the player and of the opponent character; and awarding a prize to the player when the player completes the mahjong game with a specific combination of tiles.

### BRIEF DESCRIPTION OF THE DRAWINGS

These and other objects and advantages of the present invention will be more fully apparent from the following detailed description taken in conjunction with the accompanying drawings, in which:

FIG. 1 is a perspective view showing schematically an example of a mahjong game machine according to an embodiment of the present invention;

FIG. 2 is a plan view showing schematically an operation panel 14 comprised in the mahjong game machine shown in FIG. 1;

FIG. 3 is a block diagram showing schematically an inner structure of the mahjong game machine shown in FIG. 1;

FIG. 4 is a flow chart showing a subroutine to be executed in the mahjong game machine;

FIG. 5 is a flow chart showing a competition process subroutine in a game against the opponent character to be called and executed in step S15 of the subroutine shown in FIG. 4;

FIGS. 6A to 6C show schematically an example of images to be displayed in a display device 13 when a process in the subroutine shown in FIG. 4 is executed;

FIGS. 7A to 7C show schematically an example of images to be displayed on the display device 13 when a competition process against an opponent character shown in FIG. 5 is executed;

FIGS. 8A to 8C show schematically an example of images to be displayed on the display device 13 when the process in the subroutine shown in FIG. 4 is executed;

FIG. 9 show schematically an example of a special image to be provided when a game completes with a specific combination of tiles;

FIG. 10 is a conceptional view showing schematically a network system comprising the mahjong game machine and an information processing device;

FIG. 11 is a block diagram showing schematically an inner structure of the information processing device 100 shown in FIG. 10;

FIG. 12 is a flowchart showing a subroutine to be executed on the mahjong game machine in a ranking display process routine;

FIG. 13 is a flowchart showing a subroutine to be executed on the information processing device in the ranking display process routine;

FIGS. 14A to 14D show schematically an example of images to be displayed on the display device 13 when a process in the subroutine shown in FIG. 12 is executed;

FIG. 15 is a top view showing schematically a cellular phone according to a second embodiment; and

FIG. 16 is a block diagram showing schematically an inner structure of the cellular phone shown in FIG. 15.

### DETAILED DESCRIPTION OF THE PREFERRED EMBODIMENTS

Referring now to the accompanying drawings, there is shown preferred embodiments of the invention.

First Embodiment

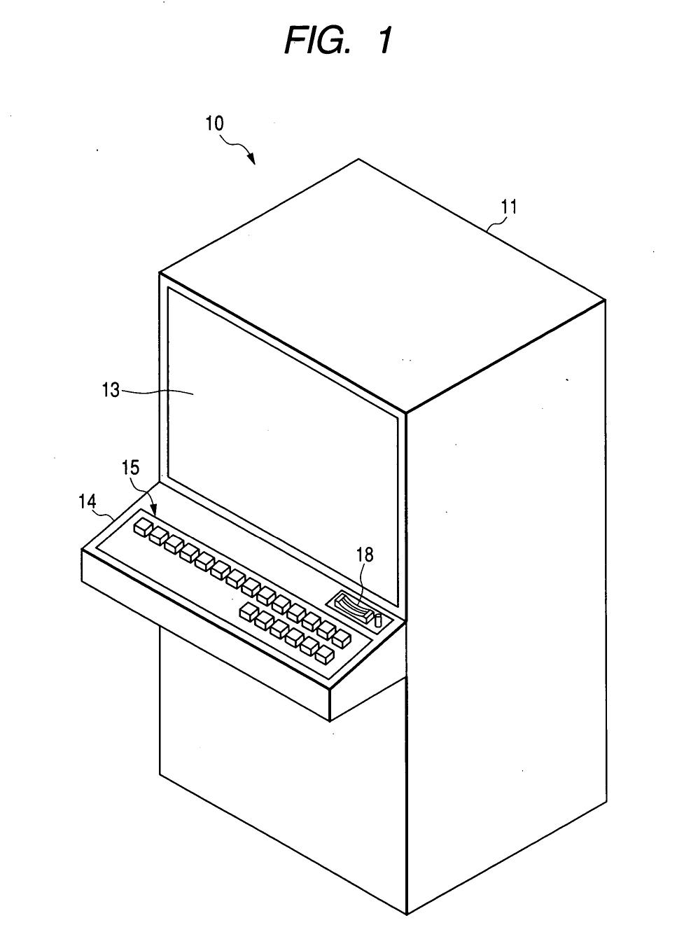

FIG. 1 is a perspective view showing schematically an example of a mahjong game machine according to a first embodiment.

The mahjong game machine shown in FIG. 1 is a game machine for commercial use which is installed in a video game arcade. However, according to the invention, the mahjong game machine for business use such as a personal game machine and a portable game machine, other than the game machine for commercial use, may be attained.

The mahjong game machine 10 is made of a longitudinal box-shaped housing 11, and a display device 13 provided on an upper side of the housing 11. The display device 13 displays an image showing a mahjong table, images showing 13 or 14 tiles representing the holding tiles of the player, images showing the discarded tiles of the player, images showing the holding tiles of the opponent character facing a rear side, images showing the discarded tiles of the opponent character. The display device 13 also displays an image showing the opponent character, images describing a dialog between the opponent characters.

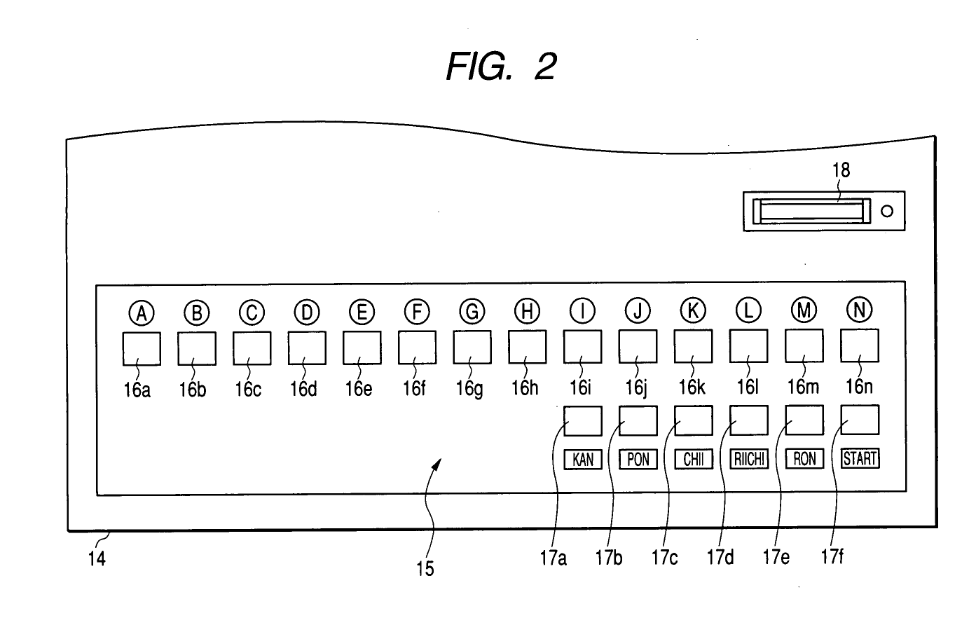

On a lower side of the display device 13, an operation panel 14 comprising an operation unit 15 is provided in such a manner to protrude at the hand of a player. The operation unit 15 includes 14 operation buttons disposed at an inner side of the operation panel 14 and 6 operation buttons provided before the hand of the player. The player operates the operation buttons of the operation unit 15 to perform various operations needed for the mahjong game. Further, the operation unit 15 will be described below with reference to a drawing (FIG. 2) in detail.

FIG. 2 is a plan view showing schematically the operation panel 14 of the mahjong game machine 10.

As shown in FIG. 2, the operation unit 15 included in the operation panel 14 includes 14 operation buttons 16 (16a to 16n) provided at an upper side of the operation panel 14 (an inner side in FIG. 1) and 6 operation buttons 17 (17a to 17f) provided at its lower side (before the hand of the player in FIG. 1). Moreover, on a right top of 14 operation buttons 16, a coin insertion slot 18 is disposed.

The 14 operation buttons 16 (16a to 16n) correspond to 14 tiles which are the holding tiles of the player displayed on the display device 13, respectively. If the operation button 16n is pressed when the number of the holding tiles of the player is 13, the pickup action of a tile is performed. Then, a new tile is displayed in a right end (position corresponding to the operation button 16n) of 13 tiles which are displayed on the display device 13, and the number of the holding tiles of the player now becomes 14. And then, if the player selects one unwanted tile among the 14 holding tiles of the player and press the operation button 16 corresponding to the unwanted tile, discarding action is performed, and the unwanted tile is eliminated from the holding tiles of the player, such that the number of the holding tiles of the player becomes 13. Further, the tile discarded as the needless is newly displayed at a portion in which the discarded tiles of the display device 13 are displayed.

The operation buttons 17a to 17e among the operation buttons 17 (17a to 17f) correspond to actions “kan”, “pon”, “chii”, “riichi” and “ron”, respectively, and further the operation button 17e is a button to be pressed when starting the mahjong game after a coin is inserted into the coin insertion slot 18.

Moreover, on the operation buttons 16 (16a to 16n) numerals, Japanese Hiragana characters, and alphabet characters are described together, such that, after displaying a screen for selecting any one condition, a special operation button is pressed, thereby selecting a predetermined condition or inputting an arbitrary sentence or a name of the player.

By operating the operation unit 15 including the above-described operation buttons 16a to 16n and operation buttons 17a to 17f, a change of the holding tiles of the player is sequentially performed. Meanwhile, the opponent character performs the same, by an automatic control of a control unit (CPU) The tiles of the opponent character are displayed in a state of facing rear side, and the player can see only the discarded tiles of the opponent character.

Further, the selection of the discarded tile or the selection of “chii”, “pon” and the like may be performed by pressing a plurality of operation buttons to move horizontally and vertically a colored portion indicating the selection on the screen, and by pressing the operation button to perform on a selected tile (particulars) and the like. These selections may be performed by using a mouse or by touching the screed. This can be applied similarly even when any one condition is selected.

The actions of picking up and discarding the tile by the player and the opponent character are alternately repeated. Occasionally, the actions of “pon”, “chii” and the like may be interposed therebetween. When the holing tiles of the player form a combination corresponding to any one of the plurality of the established combinations of the tiles (for example, “pinfu”, “tanyao” and so on), it comes to the completion, so that the player can acquire scores from the opponent character corresponding to the established combination which is completed.

Meanwhile, in case that the opponent character completes the tiles to win, the opponent character acquires scores corresponding to the established combination, and then the scores of the player are reduced.

In the embodiment, the change of the holding tiles of the player is performed by the operation of operation buttons, but, when a display corresponding to the operation buttons is shown on the screen of the display device, the mahjong game machine of the present invention may be configured to perform the above-described operation by clicking the corresponding portion.

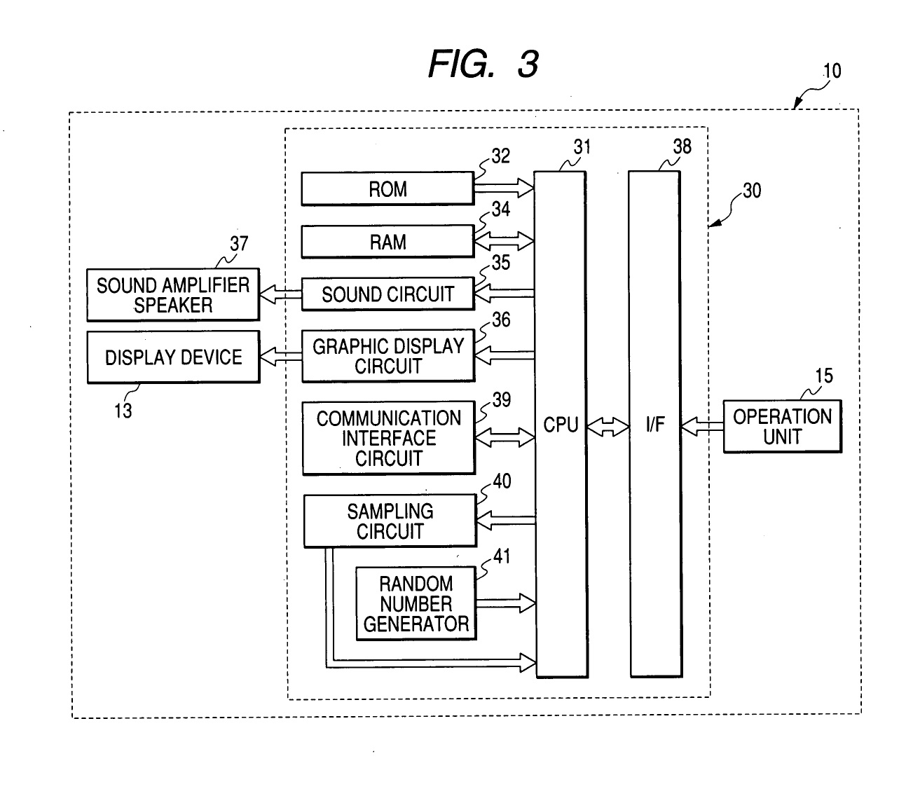

FIG. 3 is a block diagram showing schematically an inner structure of the mahjong game machine 10.

As shown in FIG. 3, a control unit 30 is provided in the housing 11 of the mahjong game machine 10. The control part 30 has a CPU (central processing unit) 31, a ROM (read only memory) 32, and a RAM (random access memory) 34.

The CPU 31 is connected to the operation unit 15 via an interface circuit (I/F) 38. The CPU 31 performs various processes based on control signals from the operation unit 15 to control the progress of the mahjong game.

The ROM 32 stores each tile to be displayed on the display device 13, various image data such as image data of the opponent character, image data which displays the opponent character and the dialog, an image showing a predetermined condition required for increasing the number of the opponent characters, a table that the specific combination of the tiles and a name of image data provided corresponding to the specific combination of the tiles, image data for displaying a special image when a game is completed with the specific combination of the tiles, a control program for the mahjong game machine for controlling a general flow of the mahjong game, a program for determining the ranking based on various data in the mahjong competition, a program for awarding points and so on when a game completes with the specific combination of the tiles, and the like. Further, the ROM 32 also stores a performance image data and so on as a performance data for every opponent character. The performance data includes image data for conducting a performance prior to playing with the opponent character, image data for conducting a performance to be conducted when the player wins or loses in the game with the opponent character, a sound data, and the like. Further, an opponent character, an image of the dialog of the opponent character, a background image and the like may be separately stored and composed as one image when being displayed on the display device 13.

Further, the sound data may be arbitrary data such as a talking voice, a shouting voice or an exclaiming voice of a human being, a data such as music, or a combination thereof. Moreover, the image of the opponent character may be an image displaying a whole body or an image displaying a part of the body such as a face. The performance may be conducted only with an image or using both the sound and the image. In the present invention, a voice data such as the talking voice of a human being is mainly used, and so, hereinafter, the sound data is considered as the voice data.

The RAM 34 stores various selection data and match data. The match data includes information regarding the winning/losing in a match with the opponent character, scores which the player acquired in the match with the opponent character, a specific combination of the holding tiles in a match completed by the opponent character or a number of times of the match completed by the opponent character. The selection data is a data, for example, showing a selection result from types of the ranking.

The CPU 31 is connected to a random number generator 41 generating a random number to be sampled, a sampling circuit 40, a sound circuit 35, a graphic display circuit 36, and a communication interface circuit (communication interface device) 39 for conducting a communication.

The sound circuit 35 is connected to a sound amplifier 37 which outputs various voices in accordance with the proceedings of the mahjong game. The graphic display circuit 34 displays an image selected by control signals from the CPU 31 in the display device 13.

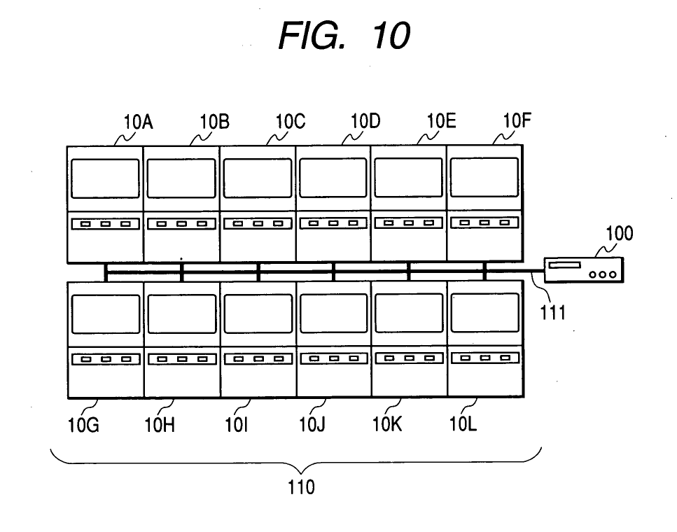

The mahjong game machine 10 installed in a video game arcade is connected an information processing device (sever) 100 which manages the data as described below, and is configured to transmit and receive the information to and from the information processing device 100 via the communication interface circuit 39 (see FIG. 10).

An example of the mahjong game performed by the mahjong game machine 10 will now be described.

(A) Game Rule

The player selects a specified opponent character among, for example, four opponent characters (for example, characters A to D), plays a match of the mahjong, and ends the game with a win or a loss.

The player and the opponent character retain predetermined scores (for example, 10,000 points) at the start time of a match, and if the scores of the opponent character becomes zero or the player repeats the match three times, the player wins. To the contrary, if the scores of the player becomes zero by the completion of a match and the like by the opponent character, the player lost.

(B) Performance

After a specified opponent character is selected, an action which the opponent character exchanges greetings with the player before the match is performed. Further, a response to an action of the player is carried out even during the competition. And then, after determining a win or a loss, a subsequent action is performed according to the match result.

(C) Ranking

By storing various data regarding match with the opponent character and determining the ranking from various standards based on the match data, the ranking (order) is decided and displayed. The standards may include, for example, a number of times won, the percentages won, an aggregate of scores in a “hanchang,” an aggregate of consecutive times won by making the scores of the opponent character to be zero, and the like. The ranking may be determined for every opponent character according to the above standard. Further, the match data is data generated as a result of playing the match, and includes not only a data regarding just the winning/losing, but also various data such as scores acquired by the player or the opponent character, a specific combination of the holding tiles completed by the player or the opponent character or the number of times or the time of the completion and the like.

(D) Awarding the Prize When a Match End With the Specific Combination of the Tiles

In the completion with the opponent character, if the player ends with the specific combination of the tiles, a predetermined prize is awarded.

The predetermined prize may include providing (displaying) of a special image, the awarding of points according to the combination of the holding tiles at the end of a match, and giving (providing) of a free gift.

‘The special image’ is an image which is rare and scarce. The special image may include, for example, an image which is especially depicted by a person who creates the opponent character (a cartoonist) to provide the special image, which is not used in other scene of the mahjong game, or an image of a movie star or an idol which is rare.

With respect to awarding of the points, the points according to value of the combination of the holding tiles (5 han, 6 han, “yakuman” etc.) are awarded to the player. For example, 200 points in case of 6 han or 300 points in case of “yakuman” are awarded to the player.

The player can store the points awarded, for example, in a memory card and so on through the memory device, thereby saving the points awarded. And then, in case that the points, for example, reach to a certain numeral value, a free gift such as a clock having depicted with an opponent character or other accessories is awarded to the player in exchange for the saved points. The free gift may be the above-described type of the special image or a special sound (verbal sound or music sound) which is not generally available are also given out to the player.

Herein, the phrase ‘Giving the free gift’ is used in a meaning that a prize such as a clock or other accessories depicted with an opponent character are given out according to the specific combination of the holding tiles of the player when the player ends the match. As to another prizes, the specified voice, music and the like may be awarded to the player according to the combination of the holding tiles at the end of a match.

The specified voices may include game voices made with words used in the actual mahjong game such as “It's riichii!”, a message-received voice informing the player the arrival of a message such as “The telephone is ringing!”, a mail voice informing the player the arrival of a mail such as “You've got a mail!”, an alarm voice for an alarm such as “Good morning!”, and the like.

The special image, the special sound (verbal sound or music sound) may be displayed in the mahjong game machine or they may be outputted from the mahjong game machine. However, the special image and the special sound may be provided to the player so as to be accessible to the player other than the mahjong game (so as to be accessible to the player beyond the mahjong game). For example, it is preferable to store them in a recording medium such as a floppy disk (FD) or a rewritable optical disk (CD-RW) via an auxiliary memory device included in the mahjong game machine. Further, an image may be printed out in addition to the above.

Further, if it is a personal mahjong game machine such as a personal computer and the like, it is preferable to download the special image and so on to a memory device such as a hard disk via the Internet.

Even when the game is ended, it is possible to display the images and the like or output the voices and the like with a personal computer. As a result, the player can enjoy these images or voices at a time other than when the mahjong game is played. Further, these special images and the like becomes an evidence for having completed a game with the specific combination of the tiles, so that the player can boast their scores to other players.

With respect to awarding of the prizes, if there is a video game arcade, the player may obtain a free gift by submitting to a counter a memory card in which the points are recorded. The player may obtain from the counter a FD or a CD-RW in which the special images or the specified voices are recorded.

The specific combination of the tiles is preferably a combination which can be rarely completed. The specific combination of the tiles may include, for example, a combination of 6 han (chinitsu), a special yakuman (churenpotou, kokushimusou, tsuitsu, daisangen, daisushi) and the like.

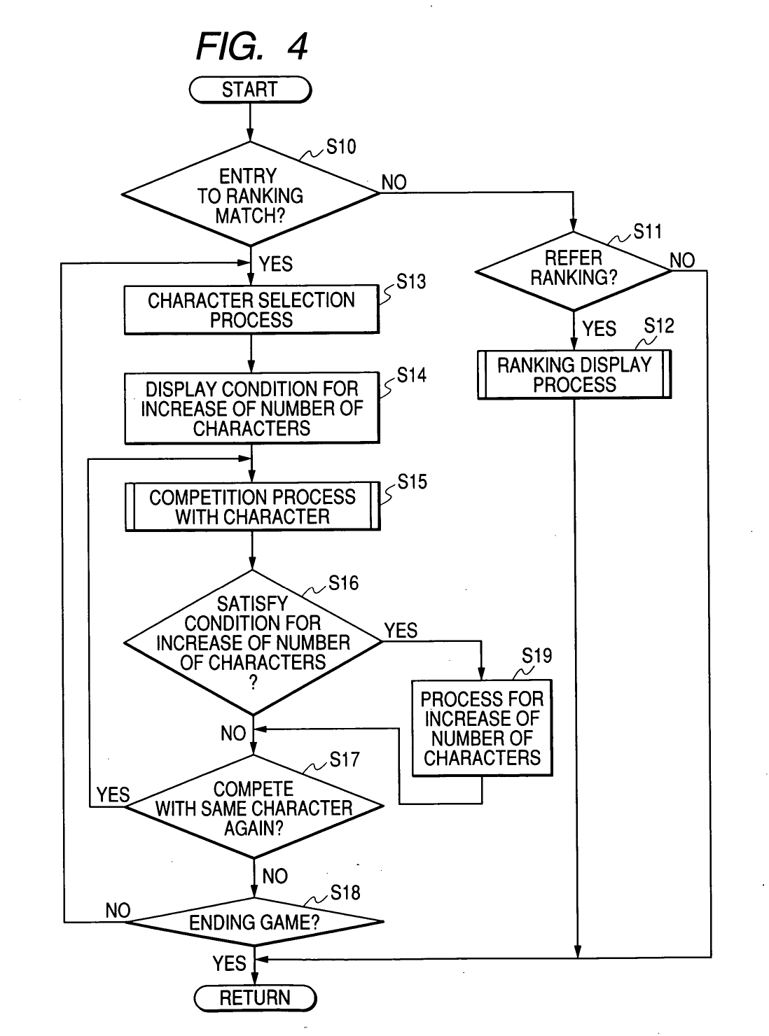

FIG. 4 is a flowchart showing a subroutine to be executed in the mahjong game machine 10. The subroutine is that executed by a call from the control program for the mahjong game machine which controls the previously executed mahjong game of the mahjong game machine 10, when the player inserts a coin into the coin insertion slot 18, and further the operation button 17f of the operation unit 15 is pressed.

At the onset of the game, the mahjong game machine 10 stores the name of a player inputted through the operation unit or an entry name to be called during the game.

Further, the mahjong game machine 10 includes a card insertion slot for inserting a memory card, read-out means for reading out a data such as the match data or the points of the player which is recorded in the memory card inserted, and writing means for writing the data such as the match data or points.

First, the CPU 31 determines whether or not the selection for an entry to the ranking match has been made (step S10).

In other words, the CPU 31 displays a screen for selecting whether or not the player wishes to play the ranking match or not, and requests the selection. The player presses of an operation button corresponding to the entry to the ranking match or presses of an operation button corresponding to other selection to select whether the entry to the ranking match or not.

In a case where determined that the player did not select to enter to the ranking match, then, the CPU 31 determines whether or not the selection for referring the ranking was been made (step S11).

In a case where determined that the selection for referring the ranking was also not made, the CPU 31 exits the subroutine. Otherwise, in a case where determined that the selection was made for referring the ranking, the ranking display process is performed (step S12). The ranking display process will be described later in detail.

In step S10, in a case where determined that the entry to the ranking match was selected, the CPU 31 displays a screen for selecting a character (step S13). That is, the CPU 31 displays a list in which a name of each character is recorded and requests the player to make a selection. The player selects an opponent character by pressing an operation button corresponding to the opponent character.

In the first game, the number of the opponent characters is set to be four, and, if a predetermined condition is satisfied in the game with the opponent characters, the selectable number of the opponent character can be increased.

In step S13, in a case where determined that the selection process of the opponent character has been made, then, the CPU 31 calls from the ROM 32 an image showing the predetermined condition required to increase the number of the opponent characters and displays it (step S14).

The condition may include, for example, a case when the same opponent character in the match has score of zero for more than 3 times consecutively or a case when win over the opponent character occurs more than five times consecutively. These conditions may be clearly stated or implied.

If the process of step S14 was executed, then, the CPU 31 proceeds the game with the opponent character (step S15).

The process of the game will be described later in detail. While, from the game, various match data such as combinations of tiles held by the player at the completion of game are stored.

If the process of game was performed in step S15, then, the CPU 31 determines whether or not the predetermined condition required to increase the number of the opponent characters is satisfied based on the competition result or not (step S16).

In a case where determined that the predetermined condition required to increase the number of the opponent character was not satisfied, the CPU 31 determines again whether or not to select the same opponent character for the next game (step 17). That is, the CPU 31 again determines whether or not to conduct next game with the same opponent character, by displaying a screen for selecting play with other opponent characters, and requests the player to make a selection.

In step S17, in a case where determined that the same opponent character was selected, the CPU 31 returns the process to step S15. In this case, the player plays against the same opponent character again.

Otherwise, in a case where determined that the same opponent character was not selected in step S17, the CPU 31 determines whether the selection to end the mahjong game was made (step S18). In a case where determined that the selection for ending the mahjong game was made in step 18, the CPU 31 exits the subroutine.

In a case where determined that the selection for ending the mahjong game was not made in step S18, it is assumed that the player decided to continue the game with other opponent characters, and the CPU 31 returns the process to step S13. In this case, the screen for selecting an opponent character is displayed.

In a case where determined that the predetermined condition required to increase the number of opponent characters is satisfied, the CPU 31 performs a process for increasing the number of opponent characters (step S19). That is, the CPU 31 selects one opponent character by holding a lottery from a character table in which currently non-selected opponent characters are recorded and stored in the ROM 32, for example, by a holding a lottery method using the random number generator 41 and the sampling circuit 40, and displays the image of the selected character.

After performing the process of step S19, step S17 is executed. The process of step S17 has been already described above, and will be omitted here.

Then, the process of the game with the opponent character will now be described.

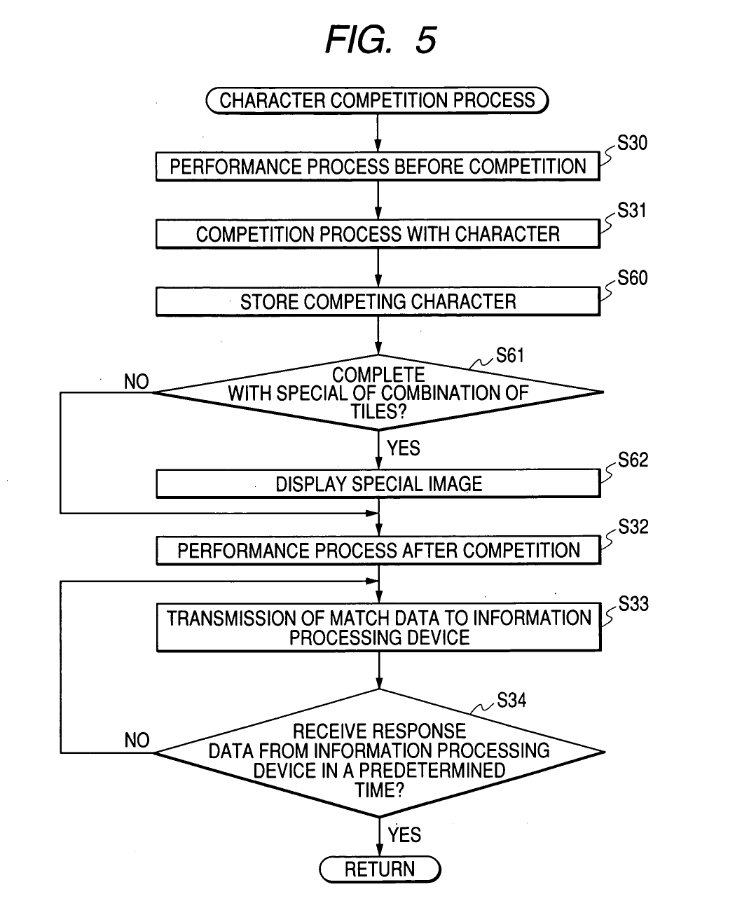

FIG. 5 is a flowchart showing a characteristic competition process routine to be called and executed in step S15 of the subroutine shown in the FIG. 4.

After an opponent character (for example, character A) was selected, the CPU 31 first executes a performance process prior to the game (step S30). That is, the CPU 31 selects image data from the image data including opponent characters stored in the ROM 32 prior to the competition, and displays it in the display device 13. The selection of the image may be conducted by holding a lottery.

The image data is the figure of the opponent characters and the dialog of the character such as “Mizuki, I am glad to see you after a long time.” Further, when the above-described screen image is displayed, a voice corresponding to the above-described dialog may be outputted from the sound amplifier 37 based on the performance data set in the RAM 34.

Then, a process of playing against the character A is executed (step S31). When step S31 is executed, the mahjong game is progressed in the above-mentioned order, is repeatedly executed until the scores of the player becomes zero, and the scores of the opponent character becomes zero or the player completes the game three times. In the game, one match is from distribution of 13 or 14 tiles, which are the first holding tiles, to the player to confirmation for end of the game by the player or the completing character (for example, character A) or not-completion (a game with no winner).

In the process of step S31, various match data including information about the competition wins/losses for the player and the opponent characters, scores which the opponent character or the player has acquired in a single game of the match, the number of times, the time of the match completed by the player or the characters, or the combination of the tiles at the end of the game are stored in the RAM 34 (step S60).

Next, the CPU 31 determines whether or not the player completes with the specific combination of the tiles (step S61).

In the embodiment, the ROM 32 is configured to store, a table, in which a predetermined combination of the tiles (or a plurality of combinations of the tiles), the name of a predetermined special image corresponding to the predetermined combination of the tiles and the like are recorded, sets a game with the opponent character, compares the completed combination of the tiles stored in the RAM 34 with the predetermined combinations of the tiles stored in the ROM 32, and determines whether the player was completed a game with corresponding specific combination of the tiles.

In a case where determined that the player has completed with a specific combination of the tiles, the CPU 31 (prize awarding device) displays a special image (step S62). In other words, the CPU 31 reads out a predetermined special image data based on the table, and displays on the display device 13. The CPU 31 may store the special image in a recording medium such as a floppy disk, instead of displaying the special image on the display device 13. The special image may also be printed out on a sheet and be awarded to the player. In step S62, the CPU 31, the RAM 34 and the like function as the prize awarding device.

In a case where the player completed with a specific combination of the tiles in the above-mentioned step, a special image is displayed. As a result, the entertainment of the player who completes a game with the specific combination of the tiles is increased. Further, completing a game with the specific combination of the tiles can be verified, and that the player can boast their scores to other players. Consequently, the player can enjoy the mahjong game for an extended period of time with becoming bored.

In a case where it is not determined that the player have completed a game with the specific combination of the tiles in step S61 nor whether the process of step S62 was executed, then, the CPU 31 executes a calculation process after the competition of a game (step S32). In the calculation process which is performed after a game, whether or not the player won the game against the opponent character is determined. Further, if the player won against the completing character, the performance corresponding to the combination of the tiles held by the player at the end of the game or the number of times the game is completed is conducted. In a case where the player lost against the completing character, a corresponding performance is conducted.

Then, the CPU 31 transmits various match data to an information processing device (step S33), and subsequently determines whether a response signal informing arrival the data is received from the information processing device in a predetermined time (step S34).

In a case where determined that the response signal was not received, the CPU 31 returns the process to step S33 and transmits the match data to the information processing device once again.

In step S34, in a case where determined that the response signal informing the arrival of the data was received from the information processing device in the predetermined time, the CPU 31 exits the subroutine.

This subroutine is configured that the mahjong game machine 10 determines that the player completes a game with a specific combination of the tiles and awards a predetermined prize. However, the present invention may be configured that the match data is transmitted to an information processing device 100, and a CPU 101 of the information processing device 100 which receives the match data determines whether the player completed a game with the specific combination of the tiles against the opponent character on a mahjong game machine 10A and awards the predetermined prize.

The relation of information processing device and the mahjong machine is described hereinafter in detail.

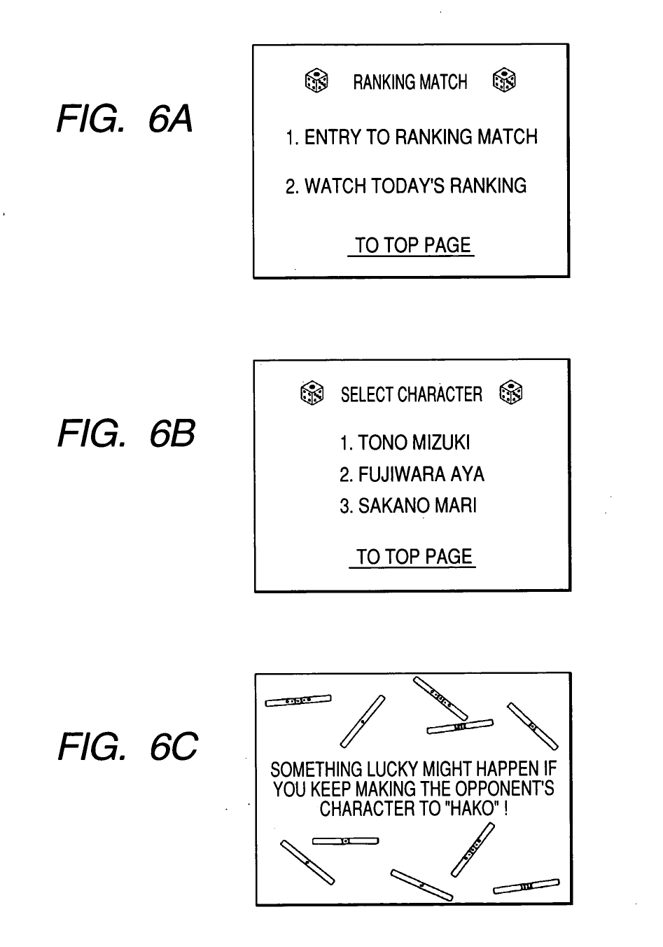

Then, when the process shown in FIG. 4 is executed, an image to be displayed on the display device 13 of the mahjong game machine 10 will be described with reference to FIGS. 6A through 8C.

FIGS. 6A to 6C show schematically an example of an image to be displayed on the display device 13 when the processes of steps S10, S11, S13 and S14 of the subroutine shown in FIG. 4, are executed.

A screen image shown in FIG. 6A is an image to be displayed when the player selects to enter the ranking match or reference of the ranking in steps S10 and S11 shown in FIG. 4.

As shown by the image, if the player presses the operation button corresponding to “1” shown in the screen, the selection to enter the ranking match is processed, and, if the player presses the operation button corresponding to “2” shown in the screen, the selection to watch the ranking is processed.

A screen image shown in FIG. 6B is an image to be displayed to select a character in step S13, in which the name and the number of each opponent character are recorded. If the operation button corresponding to “1” is pressed, a opponent character “Tono Mizuki” is selected.

A screen image shown in FIG. 6C is an image to be displayed that shows a predetermined condition required to increase the number of the opponent character. In this image, the condition is clearly described, or is implied such as “Something lucky might happen if you keep making the opponent's character to “hako” !” In such implying method, when the number of the opponent characters is increased on the screen display by making selection, the enjoyment increases.

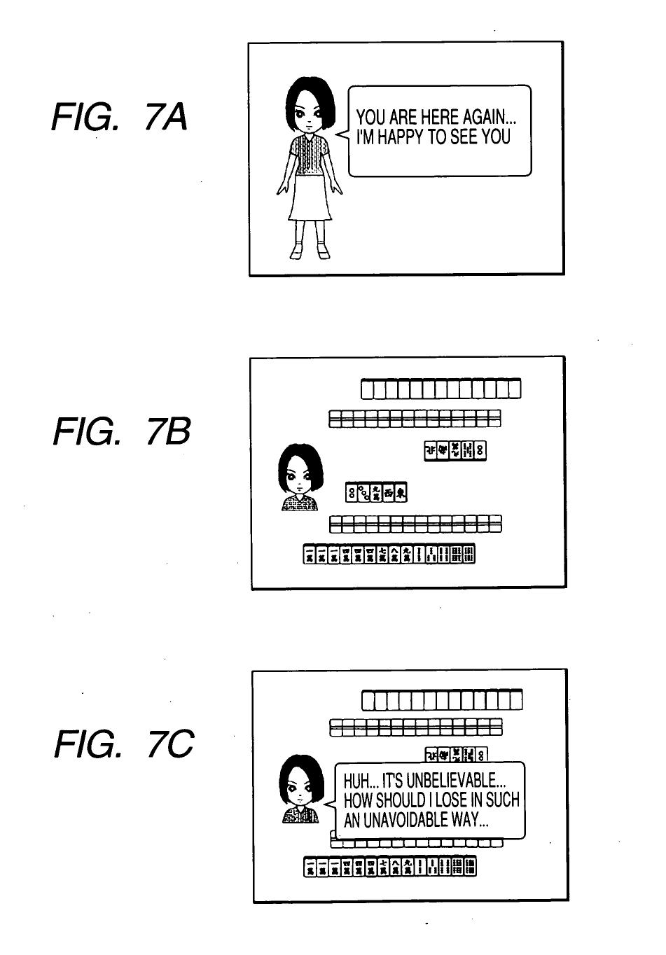

FIGS. 7A to 7C show schematically an example of an image to be displayed on the display device 13 when a game against a opponent character shown in FIG. 5 is executed.

A screen image shown in FIG. 7A is an image relating to the performance, shown the game against the opponent character of step S30.

In the image, an image showing a figure of the opponent character “Tono Mizuki” and a balloon image showing a dialog, “You are here again . . . I'm happy to see you” are displayed. Further, when the screen image shown in FIG. 7A, a voice corresponding to the dialog may be outputted from the sound amplifier 37 based on the performance data set in the RAM 34.

A screen image shown in FIG. 7B is an image relating to a performance during the game, against the opponent character of step S31.

On a lower side of the screen image shown in FIG. 7B, images showing the holding tiles of the player are displayed, and, on an upper side of the screen image, images showing the holding tiles of the opponent character are displayed. Moreover, the holding tiles of the opponent character are displayed in a state of facing rear side so that their contents cannot be viewed to the player. Further, on a lower side of the images showing the holding tiles of the opponent character, images showing the discarded tiles of the opponent character are displayed.

Further, on a central portion of the screen image, an image showing the figure of the opponent character “Tono Mizuki” is displayed. The opponent character can speak various dialogs according to scenes such as “You are calling “riichi”, so soon?” and the like during the match. At this time, it may be configured to display an image (a balloon image) showing the dialog of the opponent character.

A screen image shown in FIG. 7C is an image to be displayed on the display device 13 when a performance data corresponding to the competition result was selected in step S32 and the performance was conducted based on the performance data.

FIG. 7C displays a balloon image showing a dialog of “Tono Mizuki” saying “Huh . . . It's unbelievable . . . How should I lose in such an unavoidable way . . . ”, the dialog showing that the player won overwhelmingly.

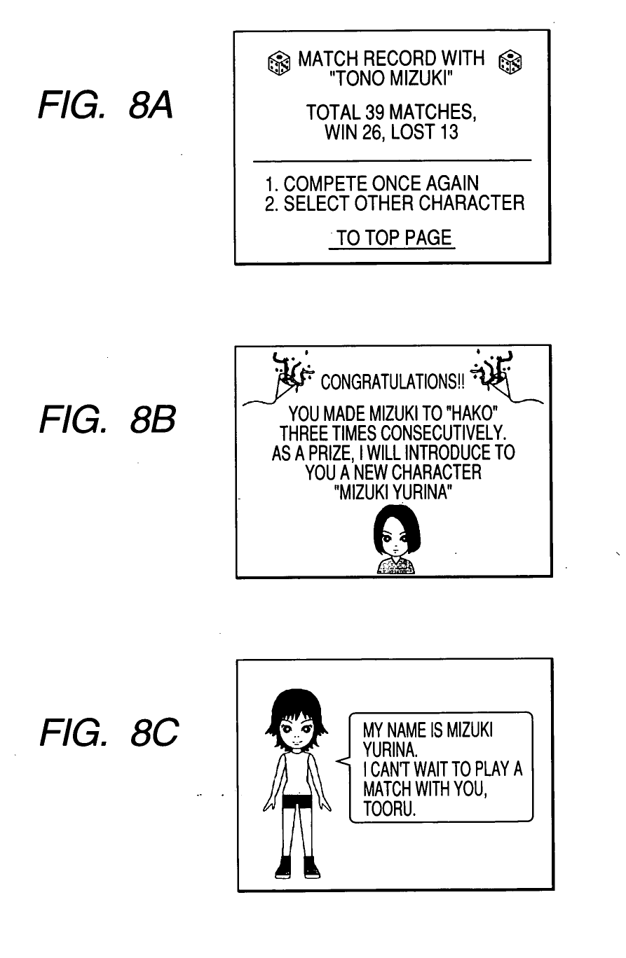

FIGS. 8A to 8C show schematically an example of an image to be displayed on the display device 13 when the processes of steps S16 and S19 of the subroutine shown in FIG. 4 are executed.

A screen image shown in FIG. 8A is an image to be displayed to select the competition with the same opponent character again or the competition with other opponent characters.

As shown in the image, the player selects the competition with the same opponent character again by pressing the operation button corresponding to “1” shown in the screen or selects the competition with other opponent character by pressing the operation button corresponding to “2” shown in the screen.

Moreover, it is configured that the player can review the competition record with the opponent characters.

Further, on a upper side of the screen, an image indicating the previous competition record against ‘Tono Mizuki’ is displayed. Therefore, it is possible to confirm the competition records against the opponent characters.

Screen images shown in FIGS. 8B and 8C are images to be displayed when the predetermined condition required to increase the number of the opponent character was satisfied in step S16.

First, as shown in FIG. 8B, a sentence such as “Congratulation” is displayed uppermost in the screen, and then an image showing a dialog “You made Mizuki to “hako” three times consecutively. As a prize, I will introduce to you a new character Mizuki Yurina.” and an image showing the figure of “Tono Mizuki” are displayed.

Subsequently, as shown in FIG. 8c, an image showing a figure of a new opponent character “Mizuki Yurina” and further a balloon image showing a dialog of “Mizuki Yurina” saying “My name is Mizuki Yurina are displayed. I can't wait to play a match with you, Tooru.” are displayed.

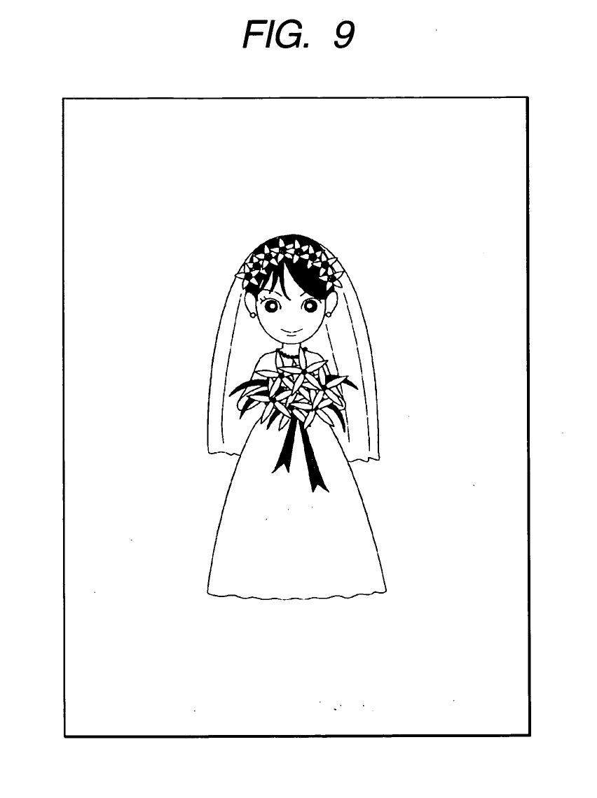

FIG. 9 shows schematically an example of a special image to be provided in step S62 of the subroutine shown in FIG. 5.

As shown in the image, “Tono Mizuki”, who is one of the opponent characters, stands in a wedding dress figure, which is entirely different costume than the normal costume worn in the mahjong game. Further, it is generally larger than the images of the opponent characters and a special image which is rare or scare.

Hereinafter, a ranking display process will be described.

A single mahjong game machine conducts the ranking display, but, if the ranking display is conducted in the video game arcade, it is easier that the player estimate his ability. Accordingly, the mahjong game machine at the video game arcade is connected to the information processing device 100 via a communication network and configured to determine the ranking by summing the total match data. Further, the ranking is displayed based on the match data every month, but it may be based on a weekly data. The communication network may be a wired network or a wireless network.

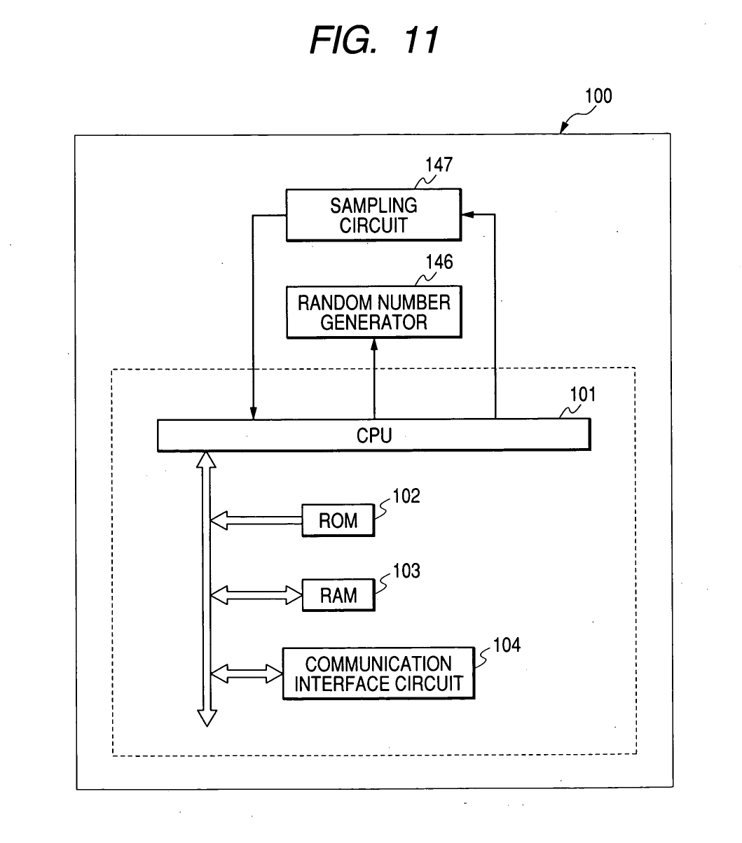

FIG. 10 is a concept ional view showing schematically a network system including the mahjong game machine shown in FIG. 1 and the information processing device, and FIG. 11 is a block diagram showing schematically an inner structure of the information processing device.

A game machine group 110 is comprised of 12 mahjong game machines 10 (10A to 10L), and these mahjong game machine 10A to 10L are connected to the information processing device 100 via a wiring or wireless network 111, respectively.

Further, as shown in FIG. 11, the information processing device 100 includes a CPU 101, a ROM 102, a RAM 103 and a communication interface circuit 104. Further, to the CPU 101, a random number generator 146 for generating a random number to be sampled and a sampling circuit 147 are connected. Further, the information processing device 100 can execute a sampling of the random number on an operating program of the CPU 101. Further, the ROM 102 stores, for example, a program for communicating with the mahjong game machine 10 via the wiring network 111 by way of the communication interface circuit 104, a program for holding a lottery, a probability-drawing table used for determining of the sampling of the random number, a ranking standard data which becomes a basis of the decision of the ranking and the like. The ROM 103 stores match data to be transmitted from the mahjong game machine 10 (10A to 10L).

Hereinafter, the processes of the above will be described in details.

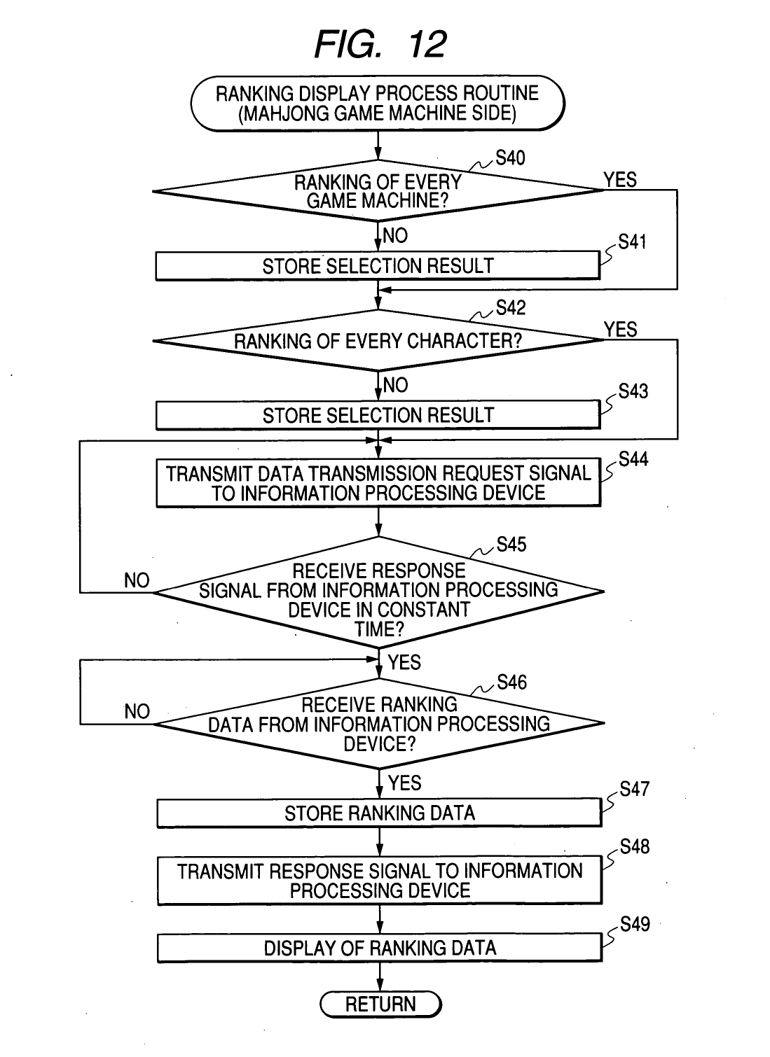

FIG. 12 is a flowchart showing a ranking process routine to be executed in the mahjong game machine 10.

Moreover, as described above, in step S33 of processing a competition against the opponent character, various match data including information about the competition wins/losses for the player and the opponent characters, scores which the player has acquired in a single game, a specific combination of tiles or the number of times of the game completed by the opponent character are stored in the RAM 34, and transmitted to the information processing device 100. In the information processing device 100, these match data are stored in the RAM 103.

The CPU 101 of the information processing device 100 performs the decision of the ranking process according to the ranking standard data stored in the ROM 102 based on the data acquired in step S33 and stores the ranking every mahjong game machine or the rankings from all of the mahjong game machines in a video game arcade.

Further, since these data include data about the opponent characters, for example, the decision to rank each opponent characters can be conducted.

Further, the ranking standard is a ranking (order) set according to various standards such as a number of times won, the percentages won, an aggregate of scores in a “hanchang,” an aggregate of consecutive times won by making the scores of the opponent character to be zero, making the scores of the opponent to be zero throughout the match from the beginning of the competition. Accordingly, the information processing device 100 adds new match data received and decides the ranking every predetermined time (for example, every five minutes).

FIG. 12 is a flowchart showing a ranking display-processing routine of the mahjong game machine side, to be called and executed in step S12 of the subroutine shown in FIG. 4.

After the reference of the ranking was selected, the CPU 31 determines whether or not the selection for displaying the ranking of each mahjong game machine is conducted (step S40).

That is, the CPU 31 displays an image for selecting the rankings of every mahjong game machine to be displayed or displaying the rankings of all of the mahjong game machines in the video game arcade, and requests the player to make a selection.

In step S40, in a case where determined that the selection displaying the rankings of every mahjong game machine was made, the CPU 31 stores its selection data in the RAM 34 (step S41).

In a case where determined that the selection displaying the rankings of every mahjong game machine was made, generally, the ranking of the mahjong game machine in which the player is engaged is displayed. While, it may be configured that the player inputs the number of a specified mahjong game machine, and the selection displaying the ranking of the specified mahjong game machine is performed.

In step S40, in a case where determined that the selection displaying the rankings of every mahjong game machine was not made, the selection displaying the rankings of all of the mahjong game machines in the video game arcade is made, so that the CPU 31 stores its selection data in the RAM 34 (step S41).

After the process in step S41 is executed, the CPU 31 determines whether or not the selection displaying the ranking of every opponent character is performed (step S42). In step S42, in a case where determined that the selection displaying the ranking of every opponent character was made, the CPU 31 stores its data in the RAM 34 (step S43).

While, in step S42, in a case where determined that the selection displaying the ranking of every opponent character was not made, the selection displaying the ranking having no distinction to the opponent characters is made, so that the CPU 31 stores its selection data in the RAM 34 (step S43).

In steps S41 and S43, based on the data stored in the RAM 34, the CPU 31 transmits a data request signal requesting the transmission of a corresponding ranking data to the information processing device 100 (step S44).

Then, in a predetermined time after transmitting of the data request signal, the CPU 31 determines whether or not a response signal informing the arrival of the data request signal from the information processing device 100 is received (step S45). This response signal is a signal to be transmitted from the information processing device 100 in a step S51 as described below.

In step S45, in a case where determined that the response signal was not received from the information processing device 100 in a predetermined time, the CPU 31 returns the process to step S41 and transmits again the data request signal requesting to transmit the corresponding data to the information processing device 100.

Otherwise, in a case where determined that the response signal informing the arrival of the request signal from the information processing device 100 was received, then, the CPU 31 determines whether or not a corresponding ranking data is received from the information processing device 100 (step S46).

This ranking data is a data to be transmitted from the information processing device 100 in a step S52 as described below.

In a case where determined that the corresponding ranking data was not received, the CPU 31 returns the process to step S46. While, in a case where determined that the corresponding data from the information processing device 100 in step S46 was received, then, the CPU 31 stores the ranking data in the RAM 34 (step S47).

After the process of step S47 was executed, the CPU 31 transmits a response signal informing the arrival of the data to the information processing device 100 (step S48).

After transmitting the response signal informing the arrival of the data regarding the corresponding ranking to the information processing device 100, the CPU 31 displays an image of the corresponding ranking in the display device 13 based on the data stored in the RAM 34 (step S49) and exits the subroutine.

Hereinafter, a ranking display process routine of the information processing device side will be described.

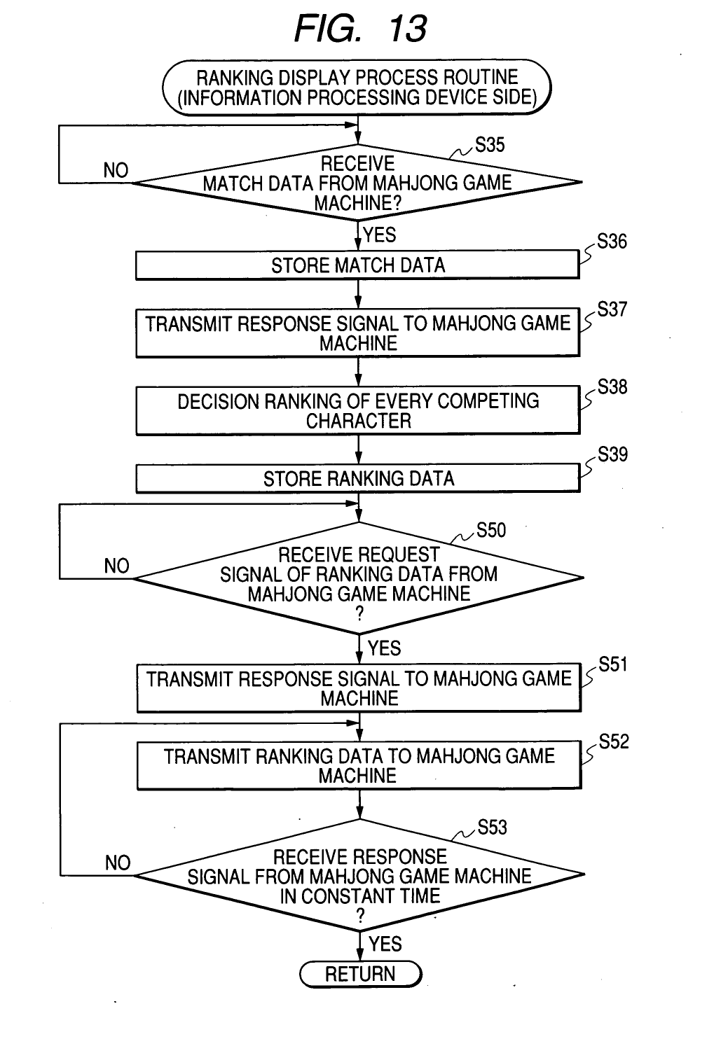

FIG. 13 is a flowchart showing the ranking display process routine of the information processing routine side to be called and executed in step S12 of the subroutine shown in FIG. 4.

In step S35, the CPU 31 determines whether or not the match data transmitted from the mahjong game machine 10A is received. In a case where determined that the match data was not received, the process returns to step S35.

While, in a case where determined that the match data was received, the CPU 101 stores the match data in the RAM 103 (step S36), and transmits a response signal informing the arrival of the data to the mahjong game machine 10A (step S37).

By repeating the process of the above, the match data from a plurality of the mahjong game machines is collected and stored, and then becomes a data for the ranking display.

Then, the CPU 101 determines the ranking of every opponent character according to the ranking standard data stored in the ROM 102 based on the match data obtained in step S37 (step S38), and stores the ranking data at a single mahjong game machine or all of the mahjong game machine in the video game arcade (step S39).

Then, the CPU 101 determines whether or not a data transmission request signal regarding a ranking display is received from the mahjong game machine 10A (step S50).

As described above, the data transmission request signal is a signal to be transmitted from the mahjong game machine 10A and in step S44.

In step S50, in a case where determined that the data transmission request signal regarding the ranking was not received from the mahjong game machine 10A, the CPU 101 returns the process to step S50. In step S50, in a case where determined that the data transmission request signal regarding the ranking was received from the mahjong game machine 10A, then the CPU 101 transmits a response signal to the mahjong game machine 10A (step S51).

After transmitting the response signal to the mahjong game machine 10A in step S51, the CPU 101 transmits the data regarding the corresponding ranking stored in the RAM 103 to the mahjong game machine 10A (step S52). It may be configured such that, every time when the data transmission request signal regarding the ranking is received from the mahjong game machine 10A, the ranking based on its contents is decided and then its result is transmitted to the mahjong game machine 10A.

After transmitting the data regarding the corresponding ranking to the mahjong game machine 10A in step S52, the CPU 101 determines whether or not a response signal informing the arrival of the corresponding data is received in a predetermined time (step S53).

In step S53, in a case where determined that the response signal was not received from the mahjong game machine 10A in the predetermined time, the CPU 101 determines that the mahjong game machine 10A did not receive the corresponding ranking, returns the process to step S52, and transmits again the data regarding the corresponding ranking to the mahjong game machine 10A.

In a case where determined that a signal informing that the mahjong game machine 10A received the corresponding data was received, the CPU 101 exits the subroutine.

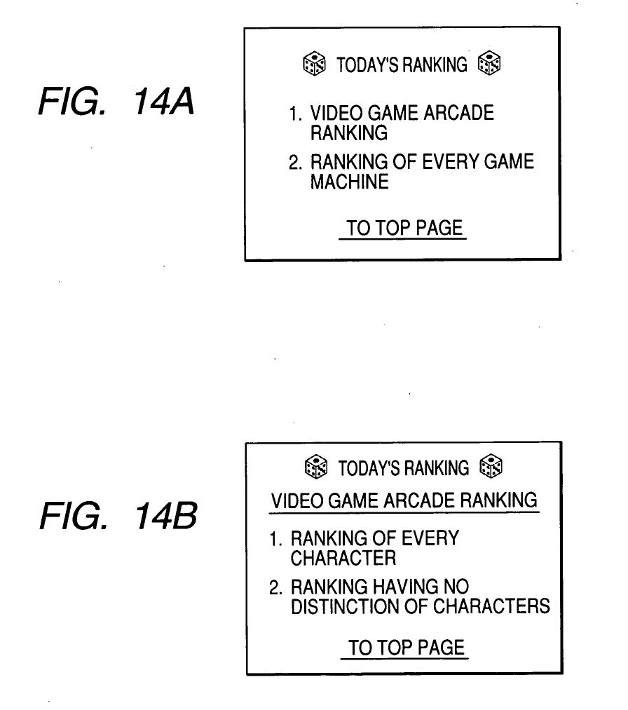

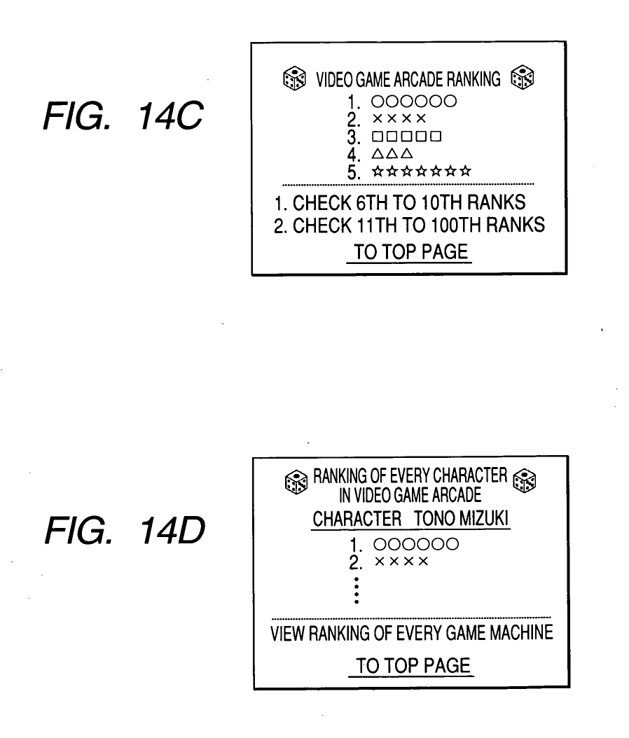

FIGS. 14A to 14C show schematically an example of an image to be displayed on the display device 13 when the processes of steps S40 to S46 of the subroutine shown in FIG. 12 are executed.

A screen image shown in FIG. 14A is an image displayed for the selection of displaying the rankings of every mahjong game machine or displaying the rankings of all of the mahjong game machines in the video game arcade in step S40.

The player selects to display the rankings of all of the mahjong game machines in the video game arcade by pressing an operation button corresponding to “1” shown in the screen, and selects to display the ranking for each of the mahjong game machine by pressing an operation button corresponding to “2” shown in the screen.

In case that displaying the ranking of all of the mahjong game machines in the video game arcade is selected in step S40, an image for selecting to display the rankings of every opponent character or display the ranking having no distinction for the opponent characters is displayed, as shown in FIG. 14B. This image is an image to be displayed in step S42.

In case that the displaying the ranking having no distinction for the opponent characters is selected in step 42, the names (or the entry names) of the players who are in the first to fifth ranks are displayed as shown in FIG. 14C. The image is an image to be displayed in step 48.

Further, in case of selecting displaying the rankings of every opponent character in step S41, the names (or the entry names) of players who are in the first to fifth ranks, in which the opponent character is “Tono Mizuki”, are displayed. This image also is an image to be displayed in step S48.

The mahjong game machine 10 is connected to the information processing device, such that it is possible to display the rankings from all of the mahjong game machines in the video game arcade. In addition, by constructing a network to which the information processing device disposed at a given area is connected via a wiring network of a wiring or wireless system, a display of the ranking in the given area becomes possible. Moreover, by constructing a network to which the information processing device is nationwide connected via a wiring network of a wiring or wireless system, a nationwide display of the ranking becomes possible.

Further, it may be configured such that, when the player wins the competition or when the ranking is displayed, special points are awarded to a player having an excellent score, and then, if the points reach a given value, a free gift or image is given out.

Second Embodiment

As described below, the second embodiment shows that the mahjong game machine of the present invention is applied to the cellular phone and the control program for the game device of the present invention is stored in the cellular phone. Moreover, the control program of the game device of the present invention is applicable to all of the electronic equipments which can store a control program for the game device and hence be able to execute the mahjong game, such as a personal computer, as well as the mahjong game machine installed at the video game arcade or the cellular phone.

The process in the cellular phone according to the second embodiment is the same as those in the subroutine shown in FIGS. 4, 5, 12 and 13, which will now be described hereinafter.

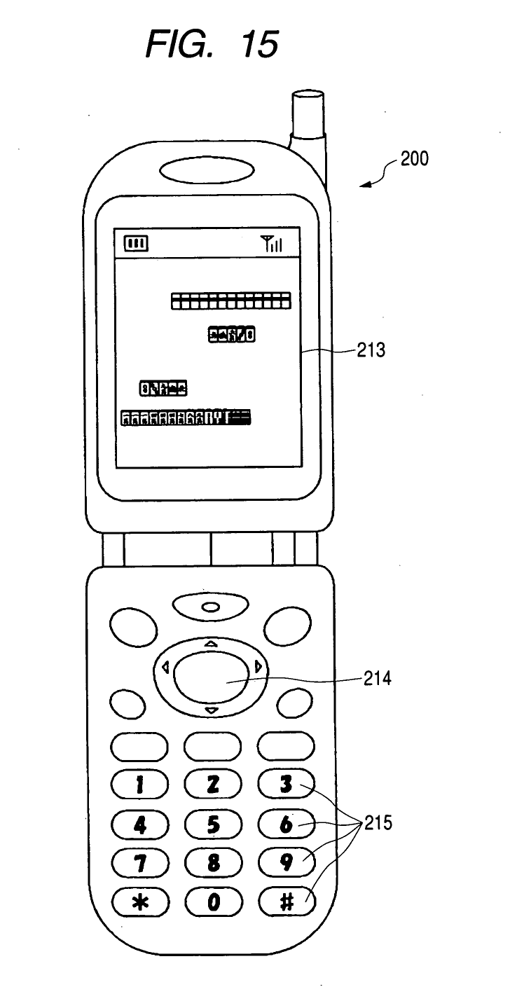

FIG. 15 is a top view showing schematically the cellular phone according to the second embodiment.

A display device 213 comprised in the cellular phone 200 displays images showing 13 or 14 tiles which are the holding tiles of the player, images showing the discarded tile of the player, images showing the holding tiles of the opponent character facing rear side, images showing the discarded tiles of the opponent character and the like. The display device 213 may display an image showing a hero playing the mahjong game or an image showing a opponent character.

Further, the cellular phone 200 includes an operation button 214 and 12 operation buttons 215 which are operating means. The player proceeds with the mahjong game, for example, by operating the operation button 214 to select the unwanted tile from the holding tiles of the player, and by operating the operation button 215 to perform an action of picking up or discarding a tile.

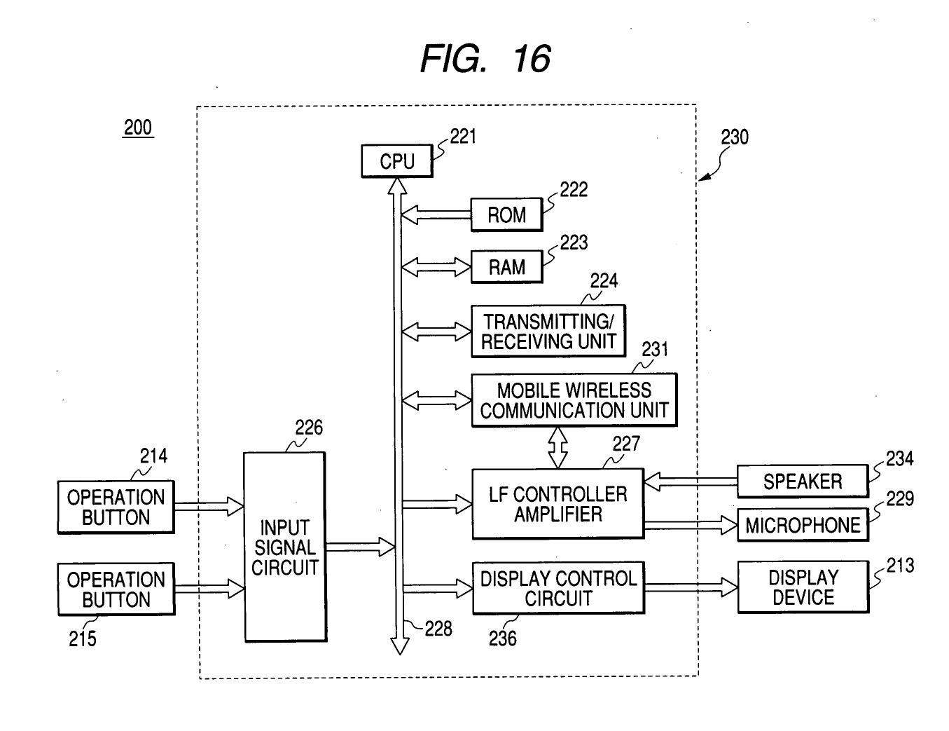

FIG. 16 is a block diagram showing schematically an example of a structure of the cellular phone 200 shown in FIG. 15.

As shown in FIG. 16, in an inner side of the cellular phone 200 is provided with a control part 230. The control part 230 includes a central processing unit (CPU) 221, a ROM 222, a RAM 223, a transmitting/receiving part (communication interface device) 224, an input/output bus 228, an input signal circuit 226, a LF controller/amplifier 227 and a display control circuit 236.

The input signal circuit 226 is connected to the operation button 214 and the operation buttons 215. Further, the input signal circuit 226 is connected to the CPU 221 via the input/output bus 228. To the input/output bus 228, the ROM 222 and the RAM 223 are also connected.

The ROM 222 stores various image data including images of each tile to be displayed on the display device 213, images of opponent characters including non-selected opponent characters, images in which a opponent character and his dialog to be displayed, images for displaying a predetermined condition required to increase the number of the opponent characters, images to be displayed for selection of a predetermined item. The ROM 222 also stores a control program for the mahjong game machine for controlling a total flow of the mahjong game, a program for determining ranking based on various data of the mahjong competition and the like. Further, the ROM 222 stores a table in which a specific combination of the tiles and the name of the special image correspond to the specific combinations of the tiles are recorded, and stores a plurality of performance data of every opponent characters. The performance data includes image data for conducting a performance before competing against a opponent character, image data or voice data to be conducted when the player wins a competition against the opponent character or the player lost the competition with the opponent character.

Further, the RAM 223 stores various selection data and match data. The match data includes information about wins/losses of a match against the opponent characters, scores which the player acquired in a game against the opponent characters, or the combination of the tiles held by the opponent character at the end of the game. The selection data is, for example, a data showing the selection result of types of the ranking.

The input/output bus 228 is also connected to the transmitting/receiving unit 224. The transmitting/receiving unit 224 is provided for communicate with an exterior device via the Internet. The input/output bus 228 is further connected to a mobile wireless communication part 232 and the LF controller/amplifier 227. The LF controller/amplifier 227 is connected to a speaker 234 and a microphone 229. The mobile wireless communication part 231 includes an antenna and the like, and transmits an outgoing call signal or receives an incoming call signal and transmits/receives voice signals during calling.

The input/output bus 228 is also connected to the display control part 236. The display control part 236 is connected to the display device 213 and supplies a display signal to the display device 213 according to a result of the calculation process in the CPU 221.

With the above-described mahjong game machine, it is not easy to form the nationwide wiring network. However, in case of the cellular phone 200, since the nationwide network via a wireless network of a server (an information processing device) and the cellular phone can be easily realized, a display of the national ranking can also be easily implemented.

In the cellular phone, for example, it may be configured such that, when completing a game with the specific combination of the tiles, a mail address for transmitting the special image from the information processing device (server) is requested, the mail address is transmitted to the information processing device (server), and then the special image is transmitted to the mail address. The downloaded image can be used as specified, for example, a standby screen of the cellular phone, and it becomes possible for player to boast the special image data by showing to other players.

Further, in the cellular phone or the personal computer, an image to be provided as the prize may be an image for a calendar or a moving image such as an animation image.

In the cellular phone 200 according to the second embodiment, various programs, performance image data, setting data and the like (hereinafter, it is referred to as a program and the like) may be previously stored in the ROM 222 and the like. Further, it may be configured to access for requesting the transmission of the program and the like from the cellular phone to the exterior server (information processing device), and receive and store the program and the like transmitted from the server.

Further, in the present invention, a program for controlling the mahjong game or a program for allowing various images to be displayed is previously stored in the cellular phone 200, so that, along with the proceedings of the mahjong game, a structure in which various necessary image data and the like are transmitted from said server becomes possible. Further, a structure in which the server supplies the cellular phone with various programs or image data stored in the server and the like to cellular phone 200 to execute the supplied program becomes possible.

Moreover, when the various programs or image data are changed or upgraded in the server and the like, a notice signal for notifying upgrading is transmitted, and the cellular phone 200 received the notice signal can process an access to the server and the like. Accordingly, it becomes possible to allow the structure to receive and store various upgraded programs or image data.

According to this structure, it is always possible to play the mahjong game based on the latest program and the like.

According to the present invention, various prizes can be awarded to the player when the player wins with the specific combination of tiles which could be rarely accomplished, so that the player's entertainment in completing a game with the specific combination of tiles is increased. Moreover, the specific combination of tiles held by the player at the end of the game can be verified, for example, according to the type of awarded prize. As a result, the player can boast their scores to other player and enjoy the mahjong game for an extended period of time without becoming bored.

As described above, the present invention provides a mahjong game machine and a control program for the mahjong game machine as described below.

According to the first aspect of the invention, a mahjong game machine (for example, a mahjong game machine 10) has display device (for example, a display device 13) for displaying images showing at least holding tiles and discarded tiles of a player and images showing discarded tiles of a opponent character (for example, characters A to D) which is a competitor of a game. The game machine provides two-player-mahjong game in which the player plays against one from a plurality of opponent characters. The game machine further includes prize awarding device for that awards a prize to the player when the player completes the mahjong game with a specific combination of tiles (See FIG. 1).

According to the first aspect of the invention, various prizes can be awarded to the player when the player won with the specific combination of tiles which could be rarely completed, so that the player's pleasure completing with the specific combination of tiles is doubled. Moreover, the completion of specific combination of tiles can be verified, for example, according to the type of the prize, so that the player can boast their scores to other player and so on and satisfactorily enjoy the mahjong game for a long time without feeling boring.

And then, according to the second aspect of the present invention, the mahjong game machine described in the first aspect is characterized by that the prize awarding device awards a prize to the player when the player completes the mahjong game with a specific combination of tiles.

According to the second aspect of the present invention, a special image having a rare value verifying the specific combination of tiles at the end of the games can be given out to the player, so that the player's entertainment is doubled when completing a game with the specific combination of tiles. Moreover, since the specific combination of tiles at the end of the game can be verified, and so the player can boast their scores to other players and more enjoy the mahjong game.

A third aspect of the present invention provides a program product for a game device.

In the program product for a game device, the game device (for example, a cellular phone 200) has display device (for example, a display device 213) in which images showing at least holding tiles and discarded tiles of a player and images showing discarded tiles of a opponent character which is a competitor of a game is displayed, further the game device can provide two-player-mahjong game in which the player plays against one from plurality of opponent characters. The program product allows the mahjong game device to be served as prize awarding device to receive a completion of a game by the player with a specific combination of tiles and to award a predetermined prize (See FIG. 16).

According to the third aspect of the invention, various prizes can be awarded to the player when the player wins with the specific combination of tiles which is rarely accomplished, such that the player's entertainment in completing with the specific combination of tiles is doubled. Moreover, the completion of specific combination of tiles can be verified, for example, according to the type of the prize. As a result, the player can boast their scores to other players and enjoy the mahjong game for an extended period of time without becoming bored.

According to a forth aspect of the present invention, in the program product for the game device according to the third aspect, it is characterized by that the prize awarding device provides a special image as the prize when the player completes the mahjong game with a specific combination of tiles.

According to the forth aspect of the invention, the special image having a rare value verifying the specific combination of tiles at the end of a game can be given out to the player, such that the player's entertainment is doubled when completing with the specific combination of tiles. Moreover, since the completion with the specific combination of tiles can be verified, the players can boast their scores to other players and more enjoy the mahjong game.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable those skilled in the art to utilize the invention in various embodiments and with various modifications as are suited to the particular use contemplated. It is intended that the scope of the invention be defined by the claims appended hereto, and their equivalents.

1. A mahjong game machine for providing a two-player-mahjong game in which a player plays the mahjong game against one from a plurality of opponent characters, the mahjong game machine comprising:
a display device that displays an image of holding tiles and discarded tiles of the player and of the opponent character; and
a prize awarding device that awards a prize to the player when the player completes the mahjong game with a specific combination of tiles.

2. The mahjong game machine according to claim 1, wherein the prize awarding device provides a special image as the prize to the player.

3. The mahjong game machine according to claim 2, wherein the prize awarding device provides the special image so as to be accessible to the player other than the mahjong game.

4. The mahjong game machine according to claim 1, wherein the prize awarding device provides a special sound as the prize to the player.

5. The mahjong game machine according to claim 4, wherein the prize awarding device provides the special sound so as to be accessible to the player other than the mahjong game.

6. The mahjong game machine according to claim 1, wherein the prize awarding device provides points as the prize to the player, the points provided according to the specific combination of the tiles and is exchangeable with a free gift.

7. The mahjong game machine according to claim 1, wherein the prize awarding device provides a free gift as the prize to the player.

8. A computer-readable program product for providing a two-player-mahjong game in which a player plays the mahjong game against one from a plurality of opponent characters, the program product for causing a computer to execute the steps of:
displaying an image of holding tiles and discarded tiles of the player and of the opponent character; and
awarding a prize to the player when the player completes the mahjong game with a specific combination of tiles.

9. The computer-readable program product according to claim 8, wherein in awarding the prize, a special image is provided as the prize to the player.

10. The computer-readable program product according to claim 9, wherein in awarding the prize, the special image is provided so as to be accessible to the player other than the mahjong game.

11. The computer-readable program product according to claim 8, wherein in awarding the prize, a special sound is provided as the prize to the player.

12. The computer-readable program product according to claim 11, wherein in awarding the prize, the special sound is provided so as to be accessible to the player other than the mahjong game.

13. The computer-readable program product according to claim 8, wherein in awarding the prize, points are provided as the prize to the player, the points provided according to the specific combination of the tiles and is exchangeable with a free gift.

14. The computer-readable program product according to claim 8, wherein in awarding the prize, a free gift is provided as the prize to the player.
